(19) United States
(12) Patent Application Publication
(10) Pub. No.: US 2007/0272804 A1
(43) Pub. Date: Nov. 29, 2007

(54) Mouse collar

(76) Inventor: Wade Hampton Tisdale, Boonville, MO (US)

Correspondence Address: Wade H. Tisdale, Jr., 512 Poplar Street, Boonville, MO, 65233, US

(21) Appl. No.: 11/590,694

(22) Filed: Oct. 31, 2006

Related U.S. Application Data
(60) Provisional application No. 60/801,174, filed on May 17, 2006.

(51) Int. Cl. F16L 3/00

(52) U.S. Cl. 248/51

(57) ABSTRACT

In this high tech computer world the lowly foam rubber mouse pad has a heretofore untapped feature which can be employed to solve a common desktop problem for the personal computer user. By making a simple enhancement of the mouse pad, which takes about 30 seconds to install, the user can take control of mouse cord movement on the desktop. The computer mouse cord, always problematic on the desktop, is collared by a simple binder clip attached to the mouse pad itself wherein the cord is squeezed snuggly against the vertical foam rubber edge of the mouse pad to give frictional control of the mouse cord length for the user at the mouse pad thereby eliminating the cord drag problem and optimizing user control of the mouse apparatus on the mouse pad with all this being accomplished in a very unobtrusive manner on the user's desktop.

This non-provisional application follows up on provisional patent application No. US60/801,174 filed May 17, 2006 entitled Mouse Collar by Wade H. Tisdale, Jr. and is incorporated into this application by reference.

### BACKGROUND OF THE INVENTION

The invention disclosed with this patent application is that the vertical foam rubber edge of the typical computer mouse pad in use today is precisely the material and methodology to control and manage the mouse cord where a standard binder clip is used to snuggly press the collared cord against the vertical edge of the mouse pad where the binder clip “bites” into foam rubber mouse pad itself rather than “biting” into the mouse cord, and this thereby establishes the friction needed to hold the cord length at the desired setting but yet allows the mouse cord length to be easily adjusted by the user by gently pulling on the mouse cord through the collar in either direction to obtain the desired length of mouse cord at the mouse pad. It is fortitudinous that this same standard binder clip, available in most any office supply store today, has removable clip installation arms because this feature allows the user to take advantage of the features discussed above and install the binder clip permanently on the vertical edge of the mouse pad and then remove the installation arms and have a very unobtrusive, permanent, inexpensive, easy to install solution to the desktop mouse cord problem.

The prior art search found multiple disclosures showing additional hardware developed for the desktop that claim frictional control of the mouse cord with use of slots, channels, notches and holes. My patent application does not utilize slots, channels, notches or holes.

The prior art search found multiple patent disclosures utilizing clips and clamps, with various notching configurations on the inside edge of the gripping surface of the clip or clamp to place resistance or friction on the mouse cord itself by “biting” the cord in order to control cord movement. My patent application disclosed herein does not utilize a “bite” of the cord itself in order to produce friction or resistance. My patent application disclosed herein does not employ teethed notches to control the cord. In this disclosure application a “collar” is used to control the cord, and it is this cord management technique which allows easy user adjustment and control of the mouse cord length discussed below.

Our prior art search found no disclosure utilizing the foam rubber vertical edge of the common mouse pad. We found no disclosure claiming a permanent solution for use directly on existing mouse pads. No individual prior art reference revealed by our search appears to disclose or suggest the total combination of features to include a clip that may hold a mouse cord and may be securely fastened to any portion of a mouse pad, the clip holding the mouse cord at an appropriate tension so as to allow a user to adjust the length of the cord by pulling gently on the cord and removable clip arms that are used to position the clip. Klinger et al. comes close by disclosing a clip that has a mouse cord run through an opening in the jaw area, but fails to include removable clip arms. Odon et al. discloses a clip that allows a user to easily adjust the length of mouse cord, but does not disclose that the clip may be positioned at any location on a mouse pad. We found no disclosure claiming the amount of friction or tension on the mouse cord is adjustable at setup or installation and then allows the user to make this setup setting of tension permanent by removing the installation arms. We found no disclosure claiming the installation apparatus can be detached and removed after installation permitting a more streamlined, smaller footprint of the frictional device. We found no disclosure claiming a low-cost, unobtrusive solution for the desktop mouse cord problem.

This enhancement to the computer mouse pad is possible because of the foam rubber material commonly used in the construction of the typical mouse pad itself, hence, a unique collaring technique may be utilized to place resistance on the cord, the cord length being easily adjusted; and since the cord length may be easily adjusted and controlled without moving or resetting the Mouse Collar clip, the clip can be permanently attached to the mouse pad; and since the clip is capable of being permanently attached to the mouse pad, the Mouse Collar clip detachable installation arms may be detached; and since the installation arms may be detached, the net result is a entirely unobtrusive, permanent, Mouse Collar clip that gives conveniently adjustable cord length control at the mouse pad.

It is remarkable that a simple solution to the desktop cord drag problem is already at hand on the desktop itself and by merely enhancing the mouse pad with a simple binder clip utilizing the foam rubber vertical edge of the mouse pad the problem is solved.

### BRIEF SUMMARY OF THE INVENTION

The problem we address here is that in the typical personal computer setup on the desktop the length of the computer mouse cord is never exactly the right length to suit the computer user.

The computer mouse cord accessory comes from the factory permanently attached to the mouse apparatus and is a set length. Manufacturers use a one-size-fits-all approach as to the length of this cord. As a result the cord is going to be too long for most mouse apparatus users.

The excess cord usually hangs down off the edge of the desktop and creates a constant drag on the cord attached to the mouse as the user uses the mouse on the mouse pad. The other scenario is that the cord is pushed to the side “out of the way” on the desktop so that the excess cord is bunched up on the desktop. Either way, the problem addressed is that the cord is too long and it does get in the way.

Some computer users place the computer central processing unit console on the floor and the mouse cord attachment then hangs down over the edge of the desktop. The weight of the cord hanging down over the edge of the desktop places a constant drag on the cord/mouse apparatus sitting on the desktop mouse pad. This drag effect tends to inhibit complete freedom of use of the mouse on the mouse pad. It becomes a constant irritation.

MouseCollar effectively secures the cord at the mouse pad at the desired length to accommodate the use of the mouse on the pad and eliminates the drag effect of the excess cord. Additionally, MouseCollar allows the user to position the mouse pad and reposition the mouse pad wherever the user desires on the desktop to accommodate the work at hand and the cord length is always set just right to maximize the utilization of the mouse pad.

MouseCollar allows for easy adjustment of the length of the cord as different users reposition the mouse and the length of the cord on the mouse pad to suit their individual tastes.

It is this easy adjustment of the cord length to suit any user that allows the MouseCollar clip installation to be permanently installed on the mouse pad.

Hence, the mouse pad may be permanently enhanced. MouseCollar simply collars the mouse apparatus cord against the vertical foam rubber edge of the mouse pad. The MouseCollar makes use of the heretofore-unused foam rubberized vertical edge of the mouse pad to frictionally control cord movement at the mouse pad. The fact that MouseCollar is positioned at the mouse pad maximizes user control over the cord movement on the desktop and cord length at the user's hand.

In summary, MouseCollar eliminates the cord drag problem and allows uninhibited use of the computer mouse.

This invention discloses a solution that utilizes the foam rubber vertical edge of the mouse pad to take control and manage the mouse cord length on the desktop. A clip is employed to collar the cord snuggly against the rubber edge of the mouse pad. This solution takes control of the excess cord on the desktop by preventing the cord from intruding into the work space of the mouse pad and helps the user manage cord length to maximize mouse device efficiency on the mouse pad.

We believe this approach is unique, original, and has never been done before. We also believe this invention is the most simple, cost-effective solution available for the mouse cord.

We believe there are millions and millions of foam rubberized mouse pads out in public use today where users could benefit from improved desktop control of the mouse cord.

We believe the presence of this MouseCollar clip on the edge of the mouse pad creates a brand new advertising medium for corporations to get their corporate name and logo on the desktop of users.

### BRIEF DESCRIPTION OF THE DRAWINGS

The accompanying drawings, which are incorporated in and form a part of the specifications, illustrate the embodiments of the present invention and, together with the description serve to explain the principles of the invention.

In the drawings:

FIG. 1 is a cross-sectional view of the mouse collar clip installed on the mouse pad;

FIG. 2 is a top plan view of the mouse collar clip installed on the mouse pad;

FIG. 3 is a perspective view of the mouse collar clip installed on the mouse pad;

FIG. 4 is a perspective view of the mouse collar clip with the detachable installation arms;

FIG. 5 is a cover sheet for the application showing a perspective view of the mouse collar clip installed on the mouse pad.

### DETAILED DESCRIPTION OF THE INVENTION

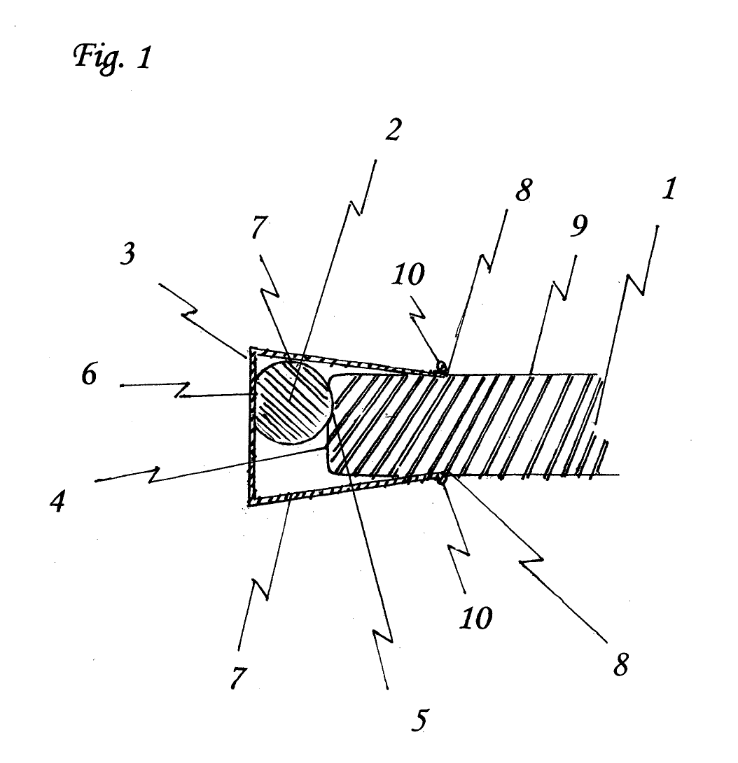

FIG. 1 is a cross-sectional view of the Mouse Collar clip installed on the mouse pad where the typical foam rubberized base mouse pad 1 in use today may be enhanced to control the electrical mouse cord 2 with a Mouse Collar clip 3. The Mouse Collar clip 3 is a standard ¾ inch binder clip having tempered steel construction and removable nickel-plated arms and may be found in any office supply store. This mouse pad 1 enhancement is possible because the mouse pad vertical edge 4 composed of foam rubber serves perfectly as the friction point 5 for the mouse cord where the smooth inside surface 6 of the Mouse Collar clip 3 becomes the pressure point to snuggly push the electrical mouse cord 2 against the mouse pad foam rubber vertical edge 4 which creates the friction point 5 for the mouse cord slippage as depicted in the drawing. The inside smooth surfaces of the sides 7 of the Mouse Collar clip effectively “collar” the cord. The Mouse Collar clip 3 pressure point where the clip “bites” 8 the mouse pad effectively secures the clip on the edge of the mouse pad 1. The key disclosure in this drawing is that the clip 3 bites the mouse pad, not the mouse cord 2, and the friction on the cord established by pushing the cord firmly against the foam rubber on the vertical edge of the mouse pad 1 at user installation gives just the right amount of resistance to hold the cord in place and keep it from slipping in normal use and yet allows the user to gently pull on the cord in either direction to control the length of cord desired. The user can adjust the frictional tension at the time of installation of the Mouse Collar clip 3 depending on how snuggly the user pushes the Mouse Collar clip 3 against the mouse cord 2 which then pushes the cord against the foam rubber vertical edge of the mouse pad 4. The thin top surface of the mouse pad 9 is a “flat, textured natural cloth or artificial fiber material” atop the foam rubber base of the mouse pad 1. The sockets for the detachable spring pinch arms are located at the edge 10 of the Mouse Collar clip 3. The vertical edge of the foam rubber mouse pad 1 in use today is typically ⅛ inch to ¼ inch thick.

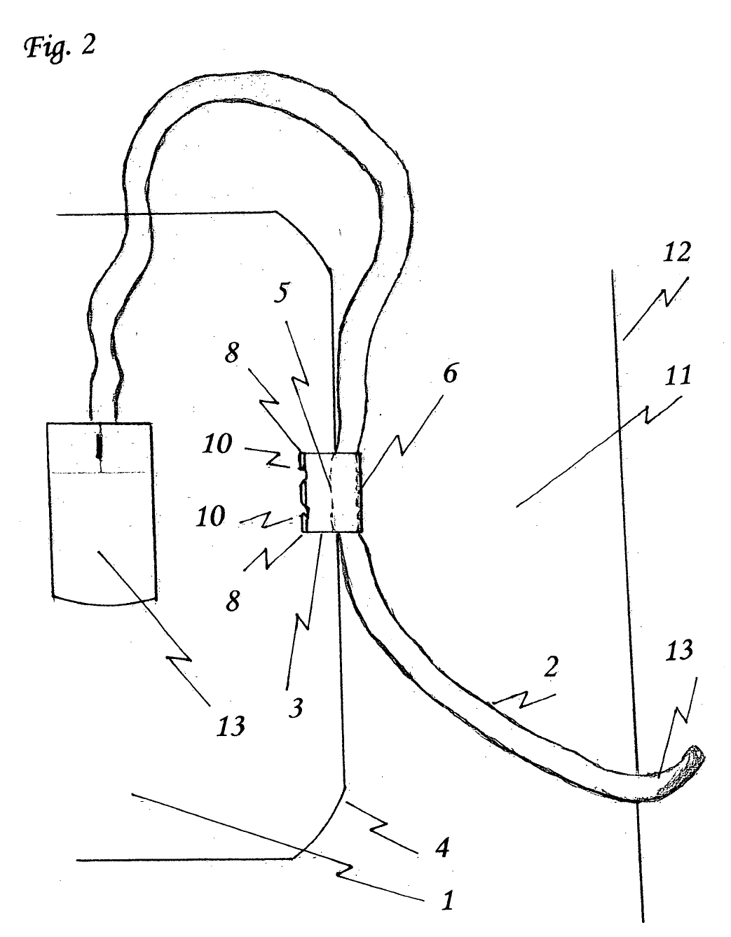

FIG. 2 is a top plan view of the Mouse Collar clip 3 installed on the foam rubberized mouse pad 1 which rests on the desktop 11 with the edge of the desktop 12 depicted. The mouse electrical cord 2 connects the mouse pointing apparatus 13 to the computer central processing unit that may typically be located elsewhere than on the desktop. Any excess mouse cord 2 may hang over the edge of the desktop 12 and create a cord drag against the uninhibited free use of the mouse pointing apparatus 13 on the mouse pad 1 unless some frictional devise is used to control the cord as depicted with the Mouse Collar clip 3. The excess mouse cord 2 may actually be bunched up on the desktop 11 and in the user's way because there is no way to control the cord and no place to put it unless a Mouse Collar clip 3 is utilized. When it is utilized the excess cord 2 can then just be pushed off the back edge of the desktop to get it out of the way and the Mouse Collar clip will prevent the cord drag issue discussed above. It is this capability to effectively control the length of cord and establish the desired slack of the cord at the mouse pad that gives each user maximum use of the mouse apparatus 13 on the mouse pad 1 and hence enhances productivity. The Mouse Collar clip 3 controls the movement of the cord 2 at the mouse pad 1 and promotes free uninhibited use of the mouse apparatus 13 by the user and hence enhances productivity.

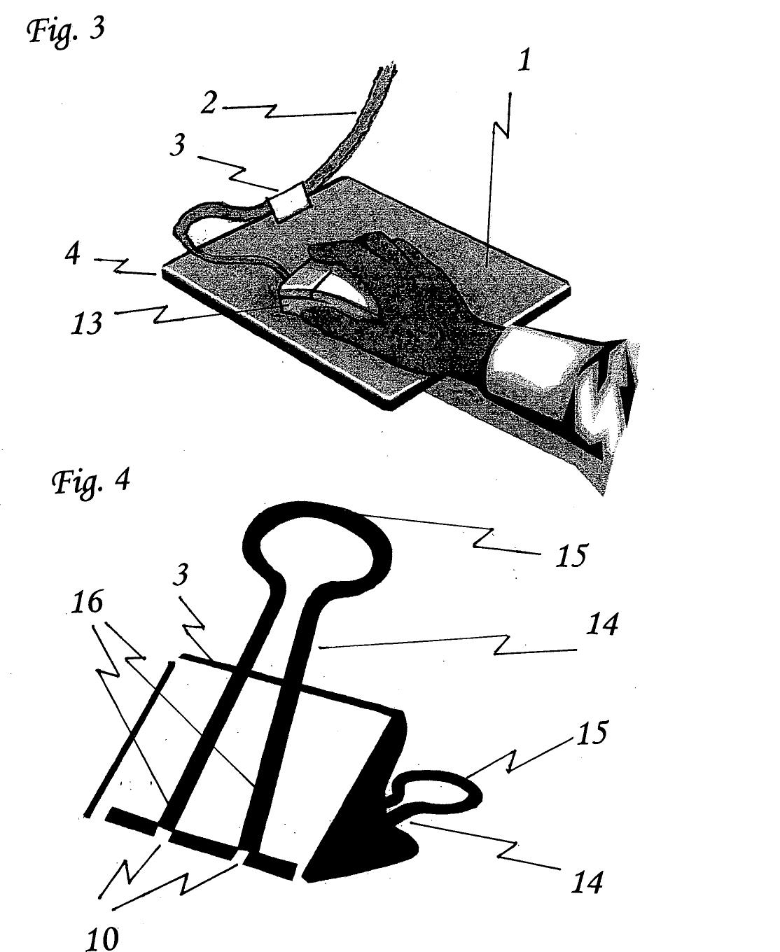

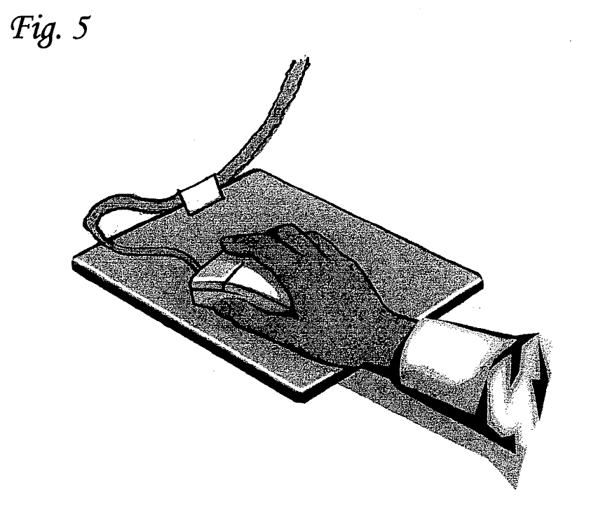

FIG. 3 is a perspective view of the Mouse Collar clip 3 installed on the mouse pad 1 which illustrates the unobtrusive nature of the clip in daily desktop operations. When a new user is working the mouse apparatus 13 they have the ability to pull gently on the cord 2 from either direction to change the cord length setting at the mouse apparatus 13; they need not worry that the Mouse Collar clip 3 will become dislodged from the mouse pad 1 when the cord length is adjusted by the user because it effectively “bites” into the foam rubber mouse pad 1; they have the ability to move the mouse pad 1 around on the desktop without disturbing the cord length setting and the functionality of using the mouse apparatus 13 remains intact. The functionality of the foam rubber mouse pad 1 is not effected by the installation of Mouse Collar clip 3 and continues to grip the surface of the desktop effectively and the mouse apparatus 13 continues to work at virtually all locations on the mouse pad 1. The nature of the Mouse Collar clip 3 is such that it may be installed at virtually any location along the edge of the mouse pad 1 that suits the user's taste and desktop setup whether they be left-handed or right-handed. When in use this invention may be considered to be permanently attached to the mouse pad because the cord length may be easily adjusted without resetting the Mouse Collar clip 3. This invention will work on virtually any existing mouse pad in use today of which there are millions and millions. While a different sized Mouse Collar clip 3 may be necessary in certain applications to accommodate the vertical edge 4 of the mouse pad 1 we believe the sizing presented in this disclosure of the invention will work perfectly in virtually all cases.

FIG. 4 is a perspective view of the Mouse Collar clip 3 with the detachable installation arms 14 attached. This Mouse Collar clip 3 may be installed by pressing on the hand pressure points 15 on the installation arms and squeezing to open the clip and position the clip. Once the Mouse Collar clip 3 has been properly positioned to suit the user's needs, the installation arms 14 may be detached by placing the fingers on the pressure points 16 on the installation arm 15 for a spring pinch release of the installation arm from the socket 10. We estimate that the average user can install this simple clip 3 in about 30 seconds to enhance the mouse pad 1. The great advantage of this is that the Mouse Collar clip 1 with the installation arms removed becomes a remarkable enhancement to the mouse pad and yet is totally unobtrusive with only a tiny “footprint” on the desktop. If the user decides that they want to reposition the Mouse Collar clip 3 in some other location along the edge of the mouse pad 1 then they can reverse this installation process to remove the clip 3 and reinstall it. It is difficult to imagine a more cost-effective solution to this common desktop problem than to utilize a Mouse Collar clip 3 since these clips may be mass-produced for pennies. The top and side outside surfaces of the Mouse Collar clip 3 may be used for advertising of corporate logos and this disclosure established a new medium for the advertising dollar in order to reach the desktop of the computer user.

While the preferred embodiments have been fully described and depicted for the purposes of explaining the principles of the present invention, it will be appreciated by those skilled in the art that modifications, substantiations, and changes may be made thereto without departing from the scope of the invention set forth in the appended claims.

What I claim and desire to have secure by patent is:

1. A computer mouse pad clip which collars the mouse cord snuggly against the vertical foam rubber edge of the typical mouse pad to give frictional control of mouse cord movement through said collar clip at the mouse pad and that at the same time allows easy adjustment of the mouse cord length by the user at the mouse pad comprising,
(a) a standard binder clip commonly available in any office supply store today having tempered steel construction typically referred to as a ¾ inch binder clip and,
(b) having spring-pinch removable nickel-plated installation arms and,
(c) said tempered steel binder clip being available in various colors and,
(d) any similar configuration of clip, clamp, slot, channel, notch or hole which utilizes the foam rubber vertical edge of the typical mouse pad or mimics said vertical foam rubber edge to collar the cord and give frictional control of mouse cord movement and allows easy cord length adjustment by the user at the mouse pad and,
(e) said computer mouse pad clip being generally described and disclosed in this patent application under various names as a binder clip, a mouse collar clip, a mouse pad clip, MouseCollar, or Mouse Collar clip, as the presentation warrants to add clarity and context to the presentation.

2. I claim the mouse collar clip as set forth in claim 1 wherein the typical mouse pad in use today may be enhanced to maximize user control of the mouse apparatus on the mouse pad by controlling mouse cord movement at the mouse pad thereby enhancing user productivity.

3. I claim the mouse collar clip as set forth in claim 1 wherein the mouse cord is collared inside the collar clip which is then snuggly clamped against the foam rubber vertical edge of the mouse pad when properly positioned will effectively control mouse cord movement as it frictionally holds the cord at the mouse pad in place at the desired length for user operation of the mouse apparatus on the mouse pad thereby overcoming the drag effect of the excess cord hanging down over the edge of the desktop and exerting a constant drag against the mouse apparatus on the mouse pad.

4. I claim the mouse collar clip as set forth in claim 1 wherein the frictional tension exerted on the mouse cord as the mouse cord is snuggly pressed against the foam rubber vertical edge of the mouse pad is just the right amount to retard unintentional mouse cord movement through the collar clip but yet allow the user to manually adjust the length of mouse cord available on the mouse pad by gently pulling on the mouse cord in either direction to suit the user's taste, and that in making this adjustment the mouse collar clip remains securely attached to the mouse pad and the amount of frictional tension remains unchanged.

5. I claim the mouse collar clip as set forth in claim 1 wherein the mouse collar clip merely “collars” the mouse cord rather than actually “biting” the mouse cord in order to control the mouse cord movement is the breakthrough solution which gives the user complete flexibility to manage the mouse cord on the desktop.

6. I claim the mouse collar clip as set forth in claim 1 wherein it is fortuitous that the foam rubber vertical edge or its equivalent already present on the desktop mouse pad is precisely the right material to use to exert frictional tension on the collared mouse cord and control its movement.

7. I claim the mouse collar clip as set forth in claim 1 wherein the mouse collar clip bites into the rubberized mouse pad along the edge of the mouse pad firmly grips the to the mouse pad at the location it is positioned and remains secure in that position with normal use of the mouse pad and the mouse apparatus on the mouse pad, to the extent that the mouse collar clip can be considered to be permanently attached to the mouse pad; that is, the mouse collar clip is permanently installed on the mouse pad.

8. I claim the mouse collar clip as set forth in claim 1 wherein said mouse collar clip is permanently installed on the mouse pad allows the utility of the mouse apparatus on the mouse pad and the mouse pad itself to be further enhanced when the mouse collar clip spring-pinch installation arms are removed giving greater range and flexibility of movement of the mouse apparatus on the mouse pad without any derogation of control over the mouse cord that is collared by the mouse collar clip.

9. I claim the mouse collar clip as set forth in claim 1 wherein the mouse collar clip is permanently installed on the mouse pad allows the entire mouse pad to be moved or rearranged on the desktop to suit the user's task at hand or different users at the desk on the desktop and the cord setting and control of the mouse collar cord remain unaffected.

10. I claim the mouse collar clip as set forth in claim 1 wherein when it is permanently installed on the mouse pad does not effect the grip of the rubberized mouse pad on the surface of the desktop.

11. I claim the mouse collar clip as set forth in claim 1 wherein the excess mouse cord has a tendency to be bunched up on the desktop said clip protects the cord from interfering with the user's use of the mouse pad and the mouse apparatus.

12. I claim the mouse collar clip as set forth in claim 1 wherein the mouse collar clip installation arms my the reattached to the mouse collar clip after they have been detached by reversing the detachment process, and that this allows the mouse collar clip to be repositioned at a different location along the edge of the mouse pad to suit the user.

13. I claim that the mouse collar clip as set forth in claim 1 wherein the mouse collar clip is installed is a simple process to undertake and that it takes less than a minute to accomplish and thereby enhance the mouse pad.

14. I claim that the mouse collar clip as set forth in claim 1 wherein the mouse collar clip is utilized is a cost-effective solution to the mouse cord drag problem common on most personal computer user desktop setups today since the mouse collar clip can be manufactured in mass quantities for pennies apiece.

15. I claim that the mouse collar clip as set forth in claim 1 wherein the mouse collar clip may be used on virtually any existing foam rubber-like mouse pad in use today, this allowing for the different thickness of mouse pads used today and the differing sizes of clips available to fit an application.

16. I claim that the mouse collar clip as set forth in claim 1 wherein the mouse collar clip has a top surface visible to the user establishes a brand new advertising medium for corporate advertising as large corporations seek to place their name and logos on the desktop in front of the user where the user will see them.

17. I claim that the mouse collar clip as set forth in claim 1 wherein the clip is installed on the mouse pad is the most unobtrusive desktop solution possible to control the mouse cord and thereby enhance the user computing experience.

18. I claim that the mouse collar clip as set forth in claim 1 wherein the smooth inside surfaces of the metal clip which presses the mouse cord firmly against the foam rubber vertical edge of the mouse pad, and the two side smooth surfaces of the clip which effectively collar the mouse cord and keep it positioned inside the clip, all work together in combination with the foam rubber vertical edge of the mouse pad to establish effective control over the mouse cord movement.

19. I claim that the mouse collar clip as set forth in claim 1 wherein the smooth inside top edge of the binder clip becomes the key surface to effectively controlling and adjusting the mouse cord because the combination of the smooth top inside edge of the clip and the foam rubber vertical edge of the mouse pad work together perfectly.

20. I claim that the mouse collar clip as set forth in claim 1 wherein the ¾ inch binder clip, typically described as a “small binder clip” available at most office supply stores, is precisely the proper length to effectively secure the mouse cord to the rubberized pad in the manner that permits easy adjustment by gently pulling on the mouse cord and yet remains secure from slippage of the cord in normal usage as described herein, and further, the ¾ inch binder clip as described in this application is the appropriate thickness to effectively “bite” the mouse pad and secure the mouse cord snuggly to the edge of the pad.
